(19) United States
(12) Patent Application Publication
(10) Pub. No.: US 2026/0307595 A1
(43) Pub. Date: Oct. 8, 2026

(54) VEHICLE CONSOLE HAVING A LID AND A REMOVABLE CASE ASSEMBLY

(71) Applicant: Ford Global Technologies, LLC, Dearborn, MI (US)

(72) Inventors: Stuart C. Salter, White Lake, MI (US); Jeff Robert Seaman, Petersburg, MI (US); Richard Iseppi, Detroit, MI (US); Katie Pecoraro, Ann Arbor, MI (US); Daniel Clifford, Canton, MI (US); Matthew Jameson Hickey, Canton, MI (US)

(73) Assignee: Ford Global Technologies, LLC, Dearborn, MI (US)

(21) Appl. No.: 19/169,050

(22) Filed: Apr. 3, 2025

(51) Int. Cl. B60R 11/02; B60N 2/75; B60R 11/00

(52) U.S. Cl. CPC B60R 11/0252; B60N 2/75; B60R 2011/0007

(57) ABSTRACT

A vehicle console has a housing with side walls defining a storage compartment and a top surface having an access opening for the storage compartment. A console lid is operatively coupled to the housing and configured to cover the top access opening in a closed position. The console lid has a lower lid portion coupled to the housing, an upper lid portion hingedly connected to the lower lid portion such that the upper lid portion pivots onto the top surface of the housing to provide a work surface and a removable work surface assembly disposed in the console lid. The removable work surface assembly has a bottom case configured to receive an electronic device and a clipboard coupled to the case to cover the electronic device in a closed position. The removable work surface assembly is configured to be removably retained within the console lid.

### FIELD OF THE DISCLOSURE

The present disclosure generally relates to vehicle consoles, and more particularly relates to a vehicle console having a console lid that is configurable to removably hold a display device.

### BACKGROUND OF THE DISCLOSURE

Motor vehicles are commonly equipped with storage compartments, such as consoles. For example, a center console is often installed between a driver's seat and a passenger seat in a front row of seating in a passenger motor vehicle. The center console typically has a housing defining a main storage compartment and a lid which also commonly serves as an armrest and may include one or more drink holders and other storage compartments such as trays. It would be desirable to provide for a vehicle console which offers enhanced features for use on a motor vehicle.

### SUMMARY OF THE DISCLOSURE

According to a first aspect of the present disclosure, a vehicle console has a housing with side walls defining a storage compartment and a top surface having an access opening for the storage compartment. A console lid is operatively coupled to the housing and configured to cover the top access opening in a closed position. The console lid has a lower lid portion coupled to the housing, an upper lid portion hingedly connected to the lower lid portion such that the upper lid portion pivots onto the top surface of the housing to provide a work surface and a removable work surface assembly disposed in the console lid. The removable work surface assembly has a bottom case configured to receive an electronic device and a clipboard coupled to the case to cover the electronic device in a closed position. The removable work surface assembly is configured to be retained within the console lid and removed from the console lid.

Embodiments of the first aspect of the present disclosure can include any one or a combination of the following features:
the clipboard is pivotably coupled to the case;
the clipboard is coupled to the case via one or more hinges;
the one or more hinges comprises a living hinge;
the clipboard provides a work surface on the top surface when located in the console lid;
the lower lid portion has an opening to allow access to the storage compartment through the top access opening;
the case further comprises a wireless charger configured to charge the display device;
the case further comprises an adjustable retainer for retaining the display device on the case;
the clipboard further comprises a lighting device;
a strap is coupled to the case to allow the case with the display device to be hung on a support structure;
the electronic device has a display and comprises one of a phone, a tablet and a computer; and
the vehicle console is a vehicle center console.

According to a second aspect of the present disclosure, a vehicle center console has a housing with side walls defining a storage compartment and a top surface having an access opening for the storage compartment. A console lid is operatively coupled to the housing and configured to cover the access opening in a closed position. The console lid has a lower lid portion coupled to the housing, an upper lid portion hingedly connected to the lower lid portion such that the upper lid portion pivots onto the top surface of the housing to provide a work surface and a removable work surface assembly disposed in the console lid. The removable work surface assembly has a bottom case configured to receive a display device and a clipboard cover coupled to the case to cover the display device in a closed position. The removable work surface assembly is configured to be retained within the console lid and removed from the console lid. The clipboard cover is hingedly coupled to the case via one or more hinges. The clipboard cover provides a work surface on the top surface when located in the lid.

Embodiments of the second aspect of the present disclosure can include any one or a combination of the following features:
the clipboard cover is hingedly coupled to the case via a living hinge;
the case further comprises a wireless charger configured to charge the display device;
the case further comprises an adjustable retainer for retaining the display device on the case;
the clipboard further comprises a lighting device; and
a strap is coupled to the case to allow the case with the display device to be hung on a support structure.

According to a third aspect of the present disclosure, a vehicle console lid is operatively coupled to a vehicle console to cover an access opening to a storage compartment in a closed position. The console lid has a lower lid portion configured to be coupled to the vehicle console, an upper lid portion hingedly connected to the lower lid such that the upper lid portion is configured to pivot onto a top surface of the vehicle console to provide a work surface and a removable work surface assembly disposed in the console lid. The removable work surface assembly has a bottom case configured to receive a display device and a clipboard coupled to the case to cover the display device in a closed position. The removable work surface assembly is configured to be retained within the console lid and removed from the console lid.

Embodiments of the third aspect of the present disclosure can include the following feature:
the clipboard is coupled to the case via one or more hinges.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is an upper rear perspective view of a cabin interior of a motor vehicle equipped with a front center console having a console lid and a removable work surface assembly, according to one embodiment;

FIG. 2 is an upper rear perspective view of the center console shown in FIG. 1 with the console lid in a closed position;

FIG. 3 is an upper rear perspective view of the center console lid in a deployed position for providing a work surface;

FIG. 4 is an upper rear perspective view of the center console lid showing a removable case assembly with a clipboard cover in an open position;

FIG. 5 is an upper rear perspective view of the center console lid showing the clipboard work surface assembly removed from the console lid;

FIG. 6 is an upper perspective view of the removable work surface assembly with the clipboard cover removed and exposing a display device;

FIG. 7 is an upper perspective view of the removable work surface assembly with an electronic display device arranged to be installed on the top surface;

FIG. 8 is an upper perspective view of the removable work surface assembly with the clipboard cover covering the case;

FIG. 9 is an upper rear perspective view of the console lid having the removable work surface assembly arranged according to another embodiment;

FIG. 10 is an upper perspective view of the console lid shown in FIG. 9 with the upper lid portion disassembled at the disassemblable hinge;

FIG. 11 is an upper perspective view of the upper lid portion providing a case and further illustrating the disassemblable hinge of FIG. 10;

FIG. 12 is an upper rear perspective view of the back side of a front row seat illustrating the removable work surface assembly of FIG. 6 with an electronic display device hanging from the seat headrest with straps; and

FIG. 13 is an upper perspective view of the removable work surface assembly of FIG. 6 with the straps in a stowed position.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

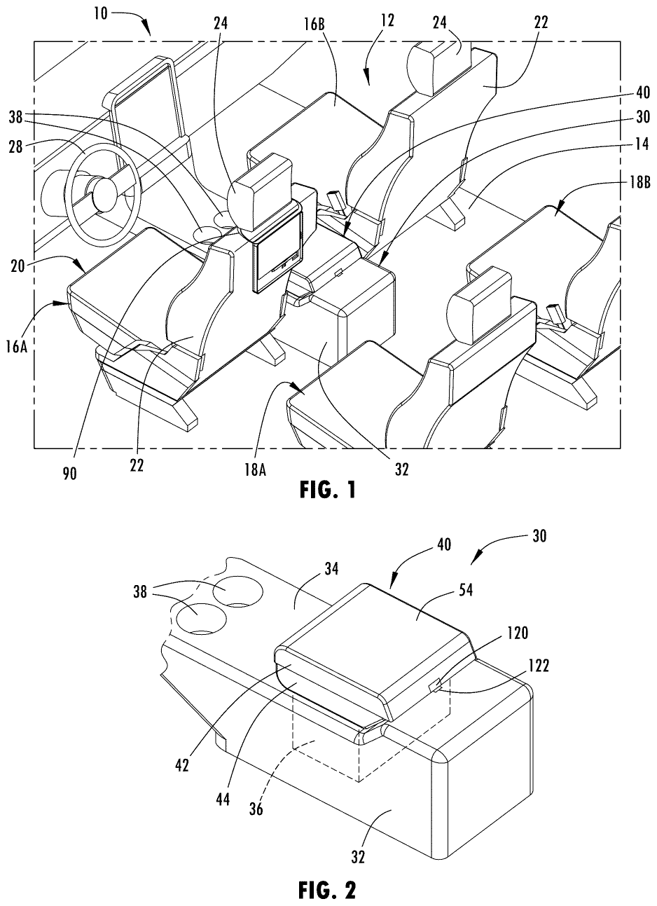

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a vehicle console having a lid with a removable work surface assembly. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

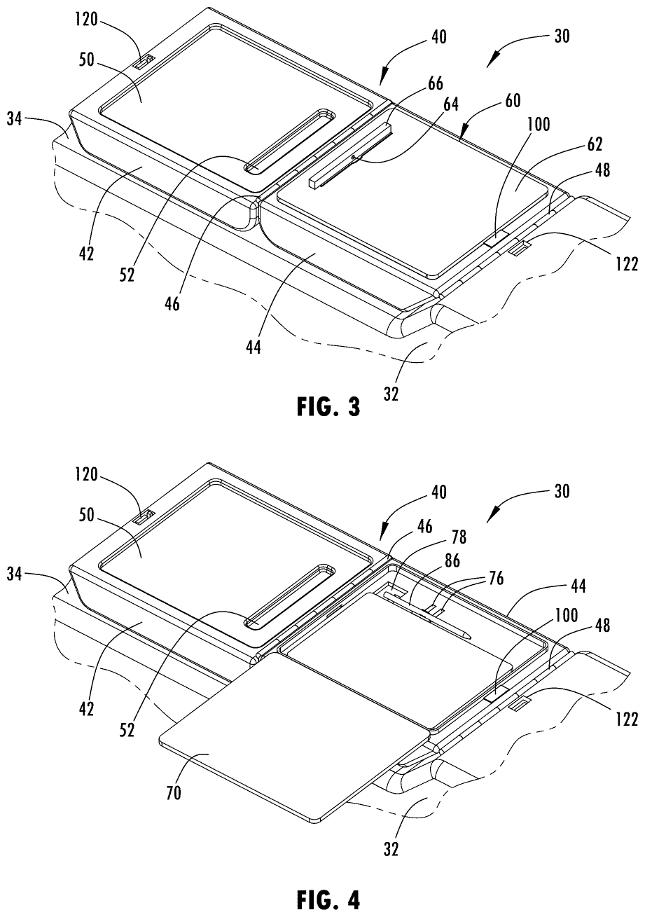

Referring to FIGS. 1-14, a vehicle console 30 for a motor vehicle 10 is generally shown and described configured as a center console. The vehicle center console 30 has a housing 32 with side walls defining a storage compartment 36 and a top surface having an access opening for access to the storage compartment. A console lid 40 is operatively coupled to the housing 32 and configured to cover the storage compartment 36 in a closed position. The console lid 40 includes a lower lid portion 44 coupled to the housing 32, an upper lid portion 42 hingedly connected to the lower lid portion 44 such that the upper lid portion 42 pivots onto the top surface 34 of the housing 32 to provide a work surface 50 and a removable work surface assembly 60 disposed in the console lid 40. The removable work surface assembly 60 includes a bottom case 68 configured to receive an electronic device 70 and a clipboard 62 coupled to the case 68 to cover the electronic device 70 in a closed position. The removable work surface assembly 60 is configured to be retained within the console lid 40 and removed from the console lid 40.

Referring specifically to FIG. 1, an automotive or motor vehicle 10 is generally illustrated configured with passenger seating for transporting one or more passengers including a driver of the motor vehicle 10 and for further transporting one or more cargo items on board the motor vehicle 10. The motor vehicle 10 generally has a vehicle body that generally defines a cabin interior 12. The cabin interior 12 may contain various features and trim components. The cabin interior 12 is shown generally having an arrangement of front row passenger seats including a first seat assembly 16A configured to seat a driver and a second seat assembly 16B configured to seat a passenger. The first and second seat assemblies 16A and 16B may be configured as captain's seats, for example, that are laterally spaced apart and separated by a space that includes a front center console 30 that may be configured according to various embodiments as shown and described herein. The motor vehicle 10 illustrated in the example also includes additional seating such as a second row of seating including third and fourth seat assemblies 18A and 18B spaced apart and separated by a space which could further include a rear center console. It should be appreciated that the motor vehicle 10 may have additional rows of seating such as is common for large sport utility vehicles (SUVs), vans, buses, etc. It should be further appreciated that the motor vehicle 10 may be a motor vehicle such as a wheeled car, truck, SUV, van or bus, for example, or an airplane, train, boat or other vehicle capable of transporting one or more passengers and cargo items.

The motor vehicle 10 is illustrated with the front row of seating having the first seat assembly 16A located on one lateral side (e.g., the left side) generally rearward of a steering wheel 26 and vehicle rearward of a dashboard 28. The second seat assembly 16B is shown positioned vehicle rearward of the dashboard 28 on the opposite lateral side (e.g., right side) of the front row of seating. Each of the vehicle seat assemblies 16A and 16B and 18A and 18B has a seat base 20 generally supported on a floor 14 of the vehicle 10 and a seat back 22 with a headrest 24 on top. Each seating assembly is generally configured for seating a passenger.

The cabin interior 12 is shown equipped with the center console 30 located in the space between the driver front seat assembly 16A and the passenger second seat assembly 16B in the front row of seating. The motor vehicle 10 may further be equipped with other vehicle consoles, such as a rear center console that may be displaced between the seating assemblies 18A and 18B on the rear row of seating. Other consoles may be provided on the motor vehicle 10 such as proximate to the backside of the front row of seats 16A and 16B.

The vehicle center console 30 has a housing 32 shown supported on the vehicle floor 14. The housing 32 has side walls that generally define a storage compartment 36 and a top panel defining a top surface with an access opening 45 provided thereon to allow access to the storage compartment 36. The vehicle center console 30 has a moveable console lid 40 that may move by pivoting between a closed position covering the storage compartment 36 and an open position allowing access to the storage compartment 36 from the top side. The console lid 40 also serves as an armrest for supporting an arm of an occupant on the top surface 54. The console lid 40 is configured with the removable work surface assembly 60 that may be removed and reinstalled on the console lid 40. The vehicle center console 30 may further include one or more drink holders 38 and other accessories.

The console lid 40, shown and described herein, is a two-piece lid assembly that includes a lower lid portion 44 hingedly connected to an upper lid portion 42 via hinge 46. The console lid 40 is shown in FIG. 2 in a folded configuration covering the top access opening 45 in the top surface 34 of the housing 32 which allows access to the underlying storage compartment 36. In this position, the top surface of the upper lid portion 42 may have a cushion and covering for serving as an armrest for one or more seated occupants.

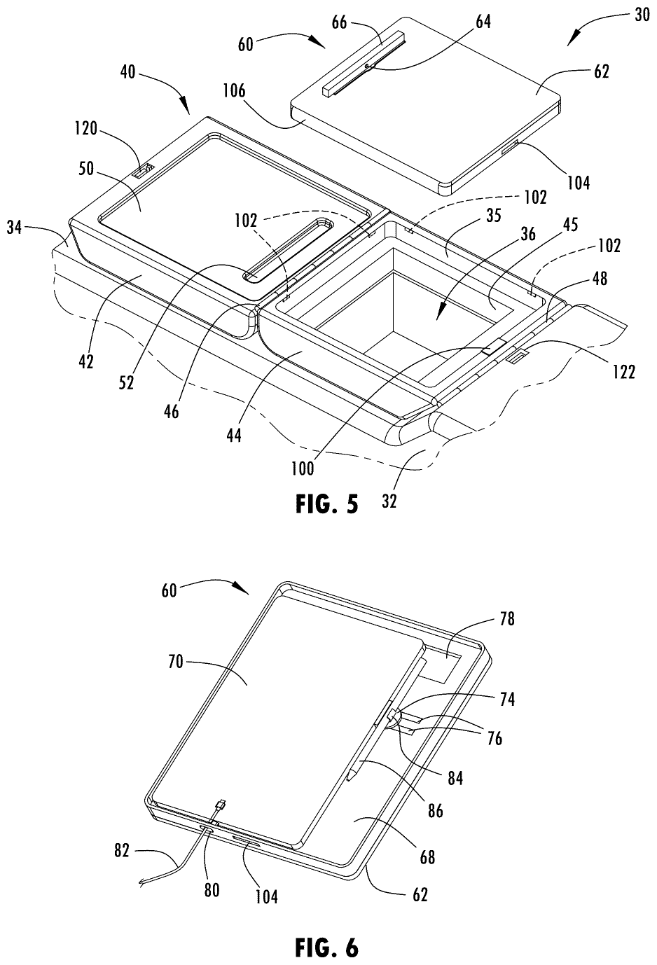

The console lid 40 may be pivotally connected at the rear end to the center console housing 32 via a rear hinge 48 to allow the console lid 40 to pivot vehicle rearward to expose the top access opening 45 and allow full access to the storage compartment 36. With the console lid 40 pivoted to the downward closed position, the upper lid portion 42 may be pivoted vehicle forward of the lower lid portion 44 about a front hinge 46 to provide an extended work surface 50. The extended work surface 50 may include a lateral elongated aperture 52. The removable work surface assembly 60 may be removed from the lower lid portion 44 as shown in FIG. 5 which also allows access to the storage compartment 36. With the removable work surface assembly 60 removed from the lower lid portion 44, a lid opening 35 operatively leads to the top access opening 45 above the storage compartment 36. As such, access to the storage compartment 36 may be achieved through the lid opening 35 and top access opening 45 in this position.

The removable work surface assembly 60 is further illustrated in FIGS. 6-8. The removable work surface assembly 60 may be installed within the lower lid portion 44 by inserting a front edge proximate to and under a lip on the hinge 46 such that it fits within the lip provided in the upper portion of the lower lid portion 44. The removable work surface assembly 60 may further be retained within the lower lid portion 44 by a plurality of detents 102 which may engage slots 104 in the removable work surface assembly 60 and a latch button 100 and a latch mechanism 122 which may be actuated to release the removable work surface assembly 60 from the lower lid portion 44. The removable work surface assembly 60 is shown substantially covering the top access opening 45 to the storage compartment 36 in this position. Once removed from the console lid 40, the removable work surface assembly 60 may be utilized as an electronic device holder and a clipboard. Specifically, the removable work surface assembly 60 includes a clipboard 62 provided proximate an upper end which may allow clipboard functionality such as a planar work surface and a clipboard retainer. The clip 64 may be received in the lateral elongated opening 52 when stored in the lid 30. The clipboard 62 may include a clip 64 at an upper end for engaging items, such as a sheet of paper. The clipboard 62 may include a lighting device 66 which may provide illumination on the front surface of the clipboard 62.

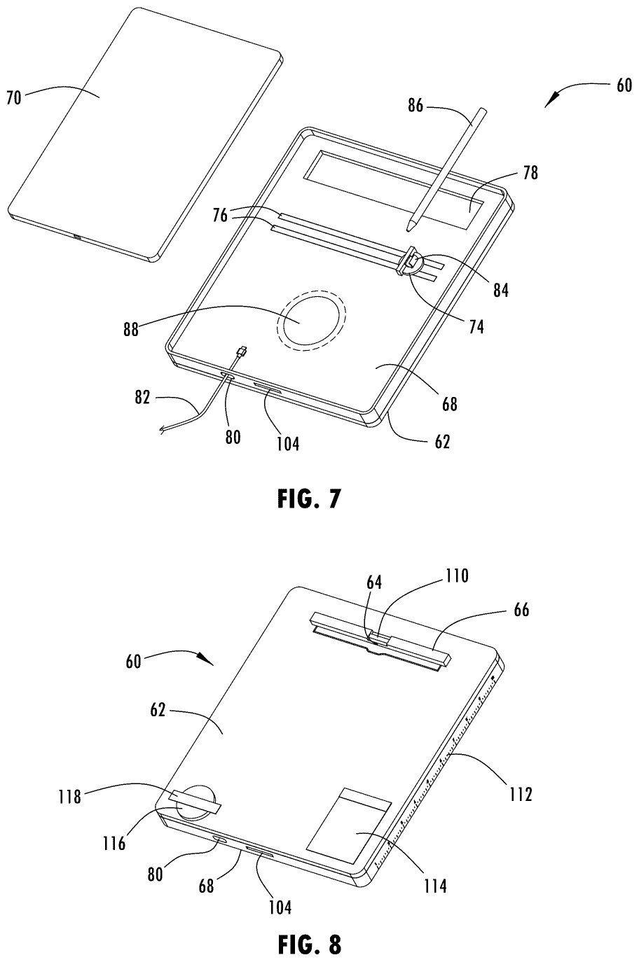

The bottom side of the removable work surface assembly 60 opposite from the clipboard 62 on the top side is shown in FIG. 6 having an electronic display device 70 provided within a case 68. The case 68 is generally formed as a tray for receiving an electronic display device 70, such as a tablet, computer or a phone, for example. The clipboard 62 serves as a cover to the case 68 and is connected to the case 68 by a living hinge 106 on one side wall. The case 68 generally has a flat bottom surface with sidewalls extending around the perimeter and includes the adjustable slider retainer mechanism 74 for engaging the portable electronic device and holding the device in place. The slider retainer mechanism 74 generally includes a slider configured to slide within a track 76 as seen in FIG. 7 which allows the slider 74 to change the width of the engagement with the electronic display device 70 to retain the electronic display device 70. The slider retainer mechanism 74 may include a writing instrument holder 84 for holding a pen or pencil 86, for example. The removable work surface assembly 60 also includes an aperture 78 which may allow the portable electronic display device 70 having a camera to align within the aperture 78.

The removable work surface assembly 60 is further configured to include one or more charging devices. For example, an inductive charger 88 is shown in FIG. 7 provided within the bottom of the case 68. The inductive charger 88 may include one or more inductive charging coils and a magnet for aligning with the electronic display device 70 and for wirelessly charging a battery pack within the electronic display device 70. Additionally, the case 68 may include a cable opening 80 such as a slot provided in a sidewall for receiving a device charging and communication cable 82 which may connect to the portable electronic display device 70 to provide electrical power and communication.

The removable work surface assembly 60 is further illustrated in FIGS. 7 and 8 having a laser level mechanism 110 shown built in to the clipboard 62 for providing a level measurement device. A ruler 112 is also shown marked along a side wall of the case 68. A business card holder sleeve 114 is provided on a surface of the clipboard 62. Additionally, an AirTag holder 118 is provided for holding an AirTag 116 on a top surface of the clipboard 62. It should be appreciated that various other accessories may be included on the removable work surface assembly 60.

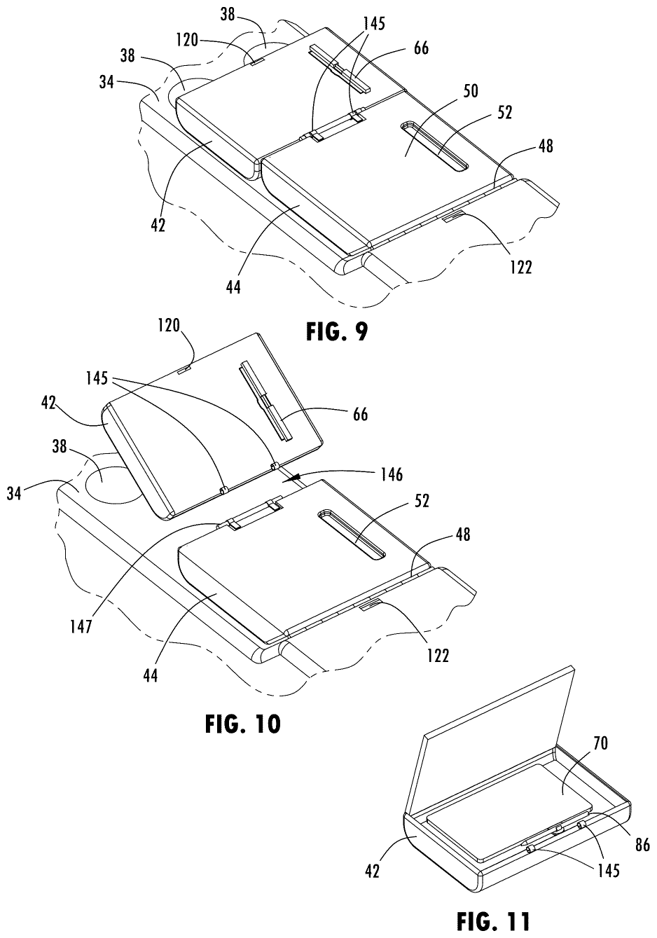

Referring to FIGS. 9-11, the vehicle center console lid 40 is shown according to another embodiment having a removable hinge 146 for connecting the upper lid portion 42 to the lower lid portion 44. The removable hinge 46 allows the upper lid portion 42 to be removed from the lower lid portion 44. In this embodiment, the removable work surface assembly 60 is provided in the upper lid portion 42 such that the entire upper lid portion 42 may be portable and may be disassembled from the lower lid portion 44 and reassembled back together onto the lower lid portion 44. The hinge 46 may include first and second hinge connectors 145 and 147 that engage and disengage from one another.

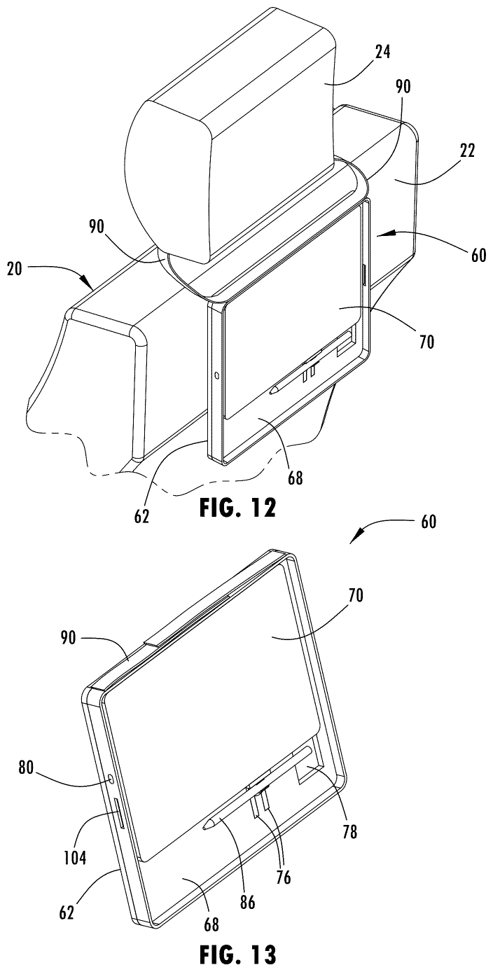

Referring to FIGS. 12 and 13, the removable work surface assembly 60 is illustrated having an adjustable strap 90 for enabling a user to hang the removable work surface assembly 60 from a support structure, according to one example. As shown in FIGS. 13 and 14, the removable work surface assembly 60 may advantageously be hung around the headrest of the vehicle seat assembly for presenting the electronic device and its display in a position to enable a user rearward of the seat to view the display. The adjustable strap 90 may include first and second strap members that may connect and adjust in size via hook and loop connectors, e.g., Velcro®, for example. It should be appreciated that other types of straps and connectors may be employed to support the removable work surface assembly 60.

Accordingly, a vehicle center console 30 is advantageously provided having a console lid 40 having upper and lower hingedly connected portions 42 and 44 and a removable work surface assembly 60 that may be removed and reinstalled within the console lid 40 and presented for use at various locations within the motor vehicle 10.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A vehicle console comprising:
a housing having side walls defining a storage compartment and a top surface having an access opening for the storage compartment; and
a console lid operatively coupled to the housing and configured to cover the top access opening in a closed position, the console lid comprising:
a lower lid portion coupled to the housing;
an upper lid portion hingedly connected to the lower lid portion such that the upper lid portion pivots onto the top surface of the housing to provide a work surface; and
a removable work surface assembly disposed in the console lid, the removable work surface assembly comprising:
a bottom case configured to receive an electronic device; and
a clipboard coupled to the case to cover the electronic device in a closed position, wherein the removable work surface assembly is configured to be retained within the console lid and removed from the console lid.

2. The vehicle console of claim 1, wherein the clipboard is pivotably coupled to the case.

3. The vehicle console of claim 2, wherein the clipboard is coupled to the case via one or more hinges.

4. The vehicle console of claim 3, wherein the one or more hinges comprises a living hinge.

5. The vehicle console of claim 1, wherein the clipboard provides a work surface on the top surface when located in the console lid.

6. The vehicle console of claim 1, wherein the lower lid portion has an opening to allow access to the storage compartment through the top access opening.

7. The vehicle console of claim 1, wherein the case further comprises a wireless charger configured to charge the display device.

8. The vehicle console of claim 1, wherein the case further comprises an adjustable retainer for retaining the display device on the case.

9. The vehicle console of claim 1, wherein the clipboard further comprises a lighting device.

10. The vehicle console of claim 1, further comprising a strap coupled to the case to allow the case with the display device to be hung on a support structure.

11. The vehicle console of claim 1, wherein the electronic device has a display and comprises one of a phone, a tablet and a computer.

12. The vehicle console of claim 1, wherein the vehicle console is a vehicle center console.

13. A vehicle center console comprising:
a housing having side walls defining a storage compartment and a top surface having an access opening for the storage compartment; and
a console lid operatively coupled to the housing and configured to cover the access opening in a closed position, the console lid comprising:
a lower lid portion coupled to the housing;
an upper lid portion hingedly connected to the lower lid portion such that the upper lid portion pivots onto the top surface of the housing to provide a work surface; and
a removable work surface assembly disposed in the console lid, the removable work surface assembly comprising:
a bottom case configured to receive a display device; and
a clipboard cover coupled to the case to cover the display device in a closed position, wherein the removable work surface assembly is configured to be retained within the console lid and removed from the console lid, wherein the clipboard cover is hingedly coupled to the case via one or more hinges, and wherein the clipboard cover provides a work surface on the top surface when located in the lid.

14. The vehicle center console of claim 13, wherein the clipboard cover is hingedly coupled to the case via a living hinge.

15. The vehicle center console of claim 13, wherein the case further comprises a wireless charger configured to charge the display device.

16. The vehicle center console of claim 13, wherein the case further comprises an adjustable retainer for retaining the display device on the case.

17. The vehicle center console of claim 13, wherein the clipboard further comprises a lighting device.

18. The vehicle center console of claim 13, further comprising a strap coupled to the case to allow the case with the display device to be hung on a support structure.

19. A vehicle console lid configured to operatively couple to a vehicle console to cover an access opening to a storage compartment in a closed position, the console lid comprising:
a lower lid portion configured to be coupled to the vehicle console;
an upper lid portion hingedly connected to the lower lid such that the upper lid portion is configured to pivot onto a top surface of the vehicle console to provide a work surface; and
a removable work surface assembly disposed in the console lid, the removable work surface assembly comprising:
a bottom case configured to receive a display device; and
a clipboard coupled to the case to cover the display device in a closed position, wherein the removable work surface assembly is configured to be retained within the console lid and removed from the console lid.

20. The vehicle console lid of claim 19, wherein the clipboard is coupled to the case via one or more hinges.
